(19) United States
(12) Patent Application Publication
(10) Pub. No.: US 2014/0160664 A1
(43) Pub. Date: Jun. 12, 2014

(54) SERIAL ADVANCED TECHNOLOGY ATTACHMENT DUAL IN-LINE MEMORY MODULE DEVICE AND MOTHERBOARD FOR SUPPORTING THE SAME

(71) Applicants: HONG FU JIN PRECISION INDUSTRY (SHENZHEN) CO., LTD., Shenzhen (CN); HON HAI PRECISION INDUSTRY CO., LTD., New Taipei (TW)

(72) Inventor: MENG-LIANG YANG, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/726,621

(22) Filed: Dec. 26, 2012

(30) Foreign Application Priority Data
Dec. 10, 2012 (CN) 201210524856.X

(51) Int. Cl. G06F 1/16

(52) U.S. Cl. CPC G06F 1/16
USPC 361/679.32

(57) ABSTRACT

A motherboard assembly includes a motherboard and a serial advanced technology attachment dual in-line memory module (SATA DIMM) device. The motherboard includes a memory slot, a SATA connector, a power connector, a switch, an integrated baseboard management controller (IBMC), a fan, and a central processing unit (CPU). The memory slot includes a protrusion, first power pins connected to the power connector, first bus pins connected to the switch, first signal pins connected to the CPU. The SATA DIMM device includes a SATA connector, a power circuit, a control chip, a temperature sensor, and a number of storage chips. A notch is defined in a bottom side of the SATA DIMM device, to receive the protrusion. An edge connector is arranged on a bottom side of the SATA DIMM device and includes second power pins connected to the power circuit, second bus pins connected to the temperature sensor.

### BACKGROUND

1. Technical Field

The present disclosure relates to a serial advanced technology attachment dual in-line memory module (SATA DIMM) device and a motherboard for supporting the SATA DIMM device.

2. Description of Related Art

At present, solid state drives (SSD) store data on chips instead of on magnetic or optical discs, to be used for adding storage capacity. One type of SSD has the form factor of a DIMM module and it is called a SATA DIMM device. The SATA DIMM device can be inserted into a memory slot of a motherboard, to receive voltages from the motherboard through the memory slot and receive hard disk drive (HDD) signals through SATA connectors arranged on the SATA DIMM device and connected to a SATA connector of the motherboard. However, SATA DIMM devices have high power consumption when operated, thus, the control chip of each SATA DIMM device may become too hot and damage the SATA DIMM device. Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawing, like reference numerals designate corresponding parts throughout the several views.

FIG. 1 is an exploded, perspective view of a serial advanced technology attachment dual in-line memory module (SATA DIMM) device and a motherboard for supporting the SATA DIMM device in accordance with an embodiment of the present disclosure.

FIG. 2 is an assembled, perspective view of the SATA DIMM device and the motherboard of FIG. 1.

FIG. 3 is an exploded, perspective view of a memory card and the motherboard of FIG. 1.

### DETAILED DESCRIPTION

The disclosure, including the drawings, is illustrated by way of example and not by way of limitation. References to “an” or “one” embodiment in this disclosure are not necessarily to the same embodiment, and such references mean at least one.

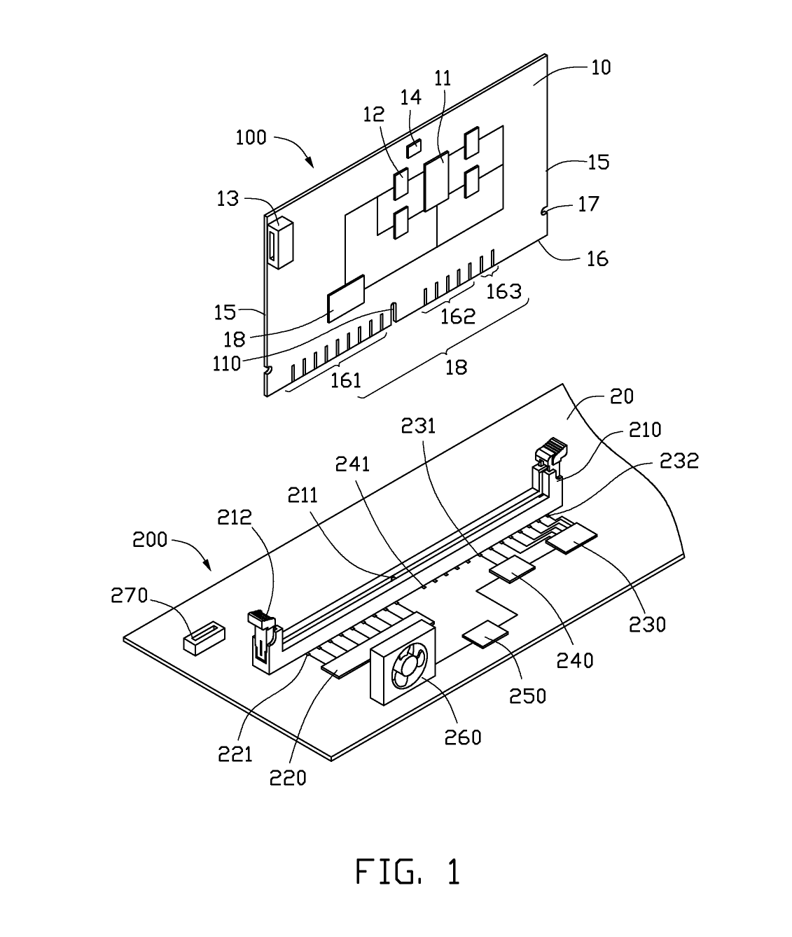

Referring to FIG. 1, a serial advanced technology attachment dual in-line memory module (SATA DIMM) device 100 in accordance with an embodiment includes a substantially rectangular circuit board 10. A control chip 11, a plurality of storage chips 12, a SATA connector 13, a temperature sensor 14, and a power circuit 18 are arranged on the circuit board 10. The SATA connector 13 is arranged on a side 15 of the circuit board 10. An edge connector 18 is arranged on a bottom side 16 of the circuit board 10. The edge connector 18 includes a plurality of power pins 161, a plurality of ground pins 162, and two bus pins 163. A notch 110 is defined in the bottom side 16 of the circuit board 10 and located between the power pins 161 and the ground pins 162. The power pins 161 are connected to the power circuit 18. The ground pins 162 are connected to a ground layer (not shown) of the circuit board 10. The bus pins 163 are connected to the temperature sensor 14. The power circuit 18 is connected to the control chip 11 and the storage chips 12 for providing voltages to the control chip 11 and the storage chips 12. The control chip 11 is connected to the SATA connector 13 for receiving SATA signals through the SATA connector 13 and also connected to the storage chips 12 to control the storage chips 12 to store data according to the received SATA signals. Two grooves 17 are defined in two opposite sides 15 of the circuit board 10 and located under the SATA connector 13. In other embodiments, the SATA connector 13 may be an edge connector, which is arranged on the circuit board 10. In one embodiment, the bus pins 163 transmit system management bus (SMbus) signals.

The motherboard 200 includes a circuit board 20. A memory slot 210, a power connector 220, a central processing unit (CPU) 230, a switch 240, an integrated baseboard management controller (IBMC) 250, a fan 260, and a SATA connector 270 are all arranged on the circuit board 20. In one embodiment, the memory slot 210 is a double data rate type three (DDR3) slot. The memory slot 210 includes a protrusion 211 arranged in the memory slot 210, two fixing elements 212 arranged on two ends of the memory slot 210, a plurality of power pins 221, a plurality of ground pins 241, two bus pins 231, and a plurality of signal pins 232. The power pins 221 are connected to the power connector 220. The ground pins 241 are connected to a ground layer (not shown) of the motherboard 200. The signal pins 232 are connected to the CPU 230. The bus pins 231 are connected to the switch 240. The IBMC 250 is connected to the switch 240 and the fan 260. In one embodiment, the bus pins 231 are pins 118 and 238 of the memory slot 210, to transmit SMbus signals.

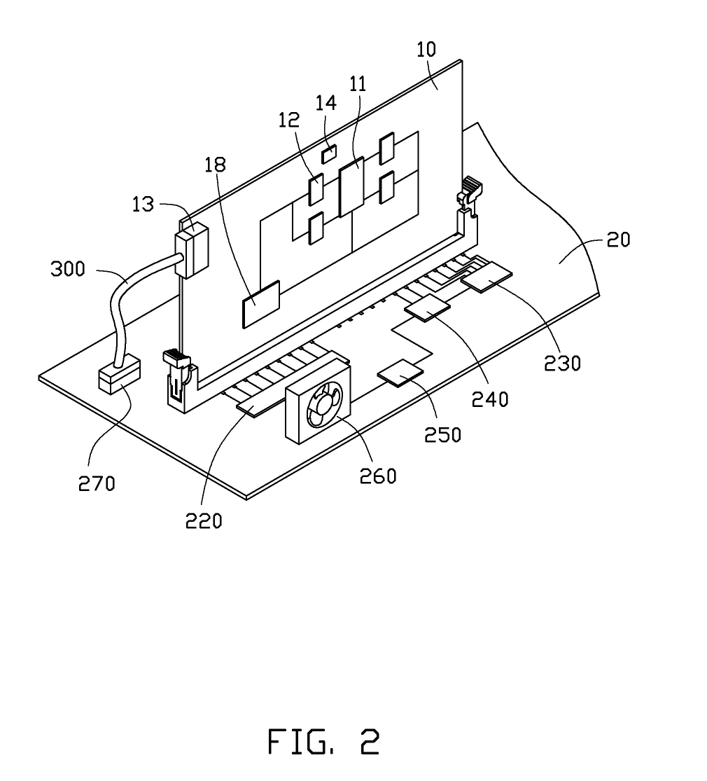

Referring to FIG. 2, in use, when the SATA DIMM module 100 is connected to the memory slot 210 through the edge connector 18 and the switch 240 is at a first state, the protrusion 211 is engaged in the notch 110. The fixing elements 212 of the memory slot 210 are engaged in the grooves 17, to fix the SATA DIMM device 100 to the memory slot 210. The power pins 161 are connected to the power pins 221, the ground pins 162 are connected to the ground pins 241, and the bus pins 163 are connected to the bus pins 231. The SATA connector 13 is connected to the SATA connector 270 through a cable 300.

When the motherboard 200 receives power, the motherboard 200 outputs a voltage to the power circuit 18 through the power connector 220 and the power pins 221 and 161. The power circuit 18 converts the received voltage and provides it to the control chip 11 and the storage chips 12. At the same time, the motherboard 200 outputs a SATA signal to the control chip 11 through the SATA connectors 270 and 13. The control chip 11 controls the storage chips 12 to store data according to the received SATA signal. The temperature sensor 14 measures a temperature of the SATA DIMM device 100 and outputs the measured temperature to the IBMC 250 through the bus pins 163 and 231 and the switch 240. The IBMC 250 controls a speed of the fan 260 to dissipate heat for the SATA DIMM device 100 according to the measured temperature.

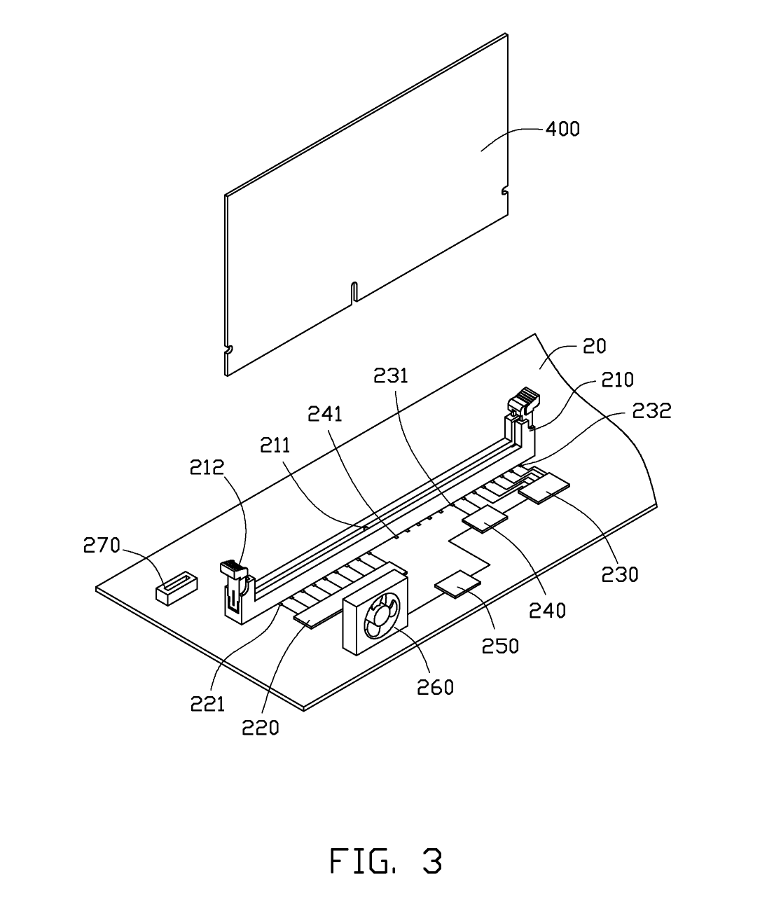

Referring to FIG. 3, when a memory card 400 is connected to the memory slot 210 of the motherboard 200 and the switch 240 is at a second state, the protrusion 211 is engaged in a notch of the memory card 400. The fixing elements 212 of the memory slot 210 are engaged in two grooves of the memory card 400, to fix the memory card 400 to the memory slot 210. Power pins of the memory card 400 are connected to the power pins 221, ground pins of the memory card 400 are connected to the ground pins 241, bus pins of the memory card 400 are connected to the bus pins 231, and signal pins of the memory card 400 are connected to the signal pins 232.

When the motherboard 200 receives power, the motherboard 200 outputs a voltage to the memory card 400 through the power connector 220 and the power pins 221. At the same time, the CPU 230 outputs a memory signal to the memory card 400 through the signal pins 232 and also outputs a bus signal to the memory card 400 through the switch 240 and the bus pins 231, to make the memory card 400 store data.

The motherboard 200 can communicate with a memory card 400 or the SATA DIMM device 100. The motherboard 200 can measure a temperature of the SATA DIMM device 100 when the motherboard 200 communicates with the SATA DIMM device 100 and control the speed of the fan 260 according to the measured temperature for dissipating heat from the SATA DIMM device 100, to prevent the SATA DIMM device 100 from being overheated.

Even though numerous characteristics and advantages of the disclosure have been set forth in the foregoing description, together with details of the structure and function of the disclosure, the disclosure is illustrative only, and changes may be made in detail, especially in matters of shape, size, and the arrangement of parts within the principles of the disclosure to the full extent indicated by the broad general meaning of the terms in which the appended claims are expressed.

What is claimed is:

1. A serial advanced technology attachment dual in-line memory module (SATA DIMM) device, comprising:
a circuit board;
a power circuit arranged on the circuit board, to receive a voltage and convert the received voltage;
a temperature sensor arranged on the circuit board;
a SATA connector arranged on the circuit board;
a plurality of storage chips arranged on the circuit board and connected to the power circuit, to receive the converted voltage from the power circuit;
a control chip arranged on the circuit board, and connected to the SATA connector, the plurality of storage chips, and the power circuit for receiving the converted voltage from the power circuit; and
an edge connector and a notch arranged on a bottom side of the circuit board, to be inserted into a memory slot of a motherboard, wherein the edge connector comprises a plurality of power pins connected to the power circuit, a plurality of ground pins, and two bus pins connected to the temperature sensor.

2. The SATA DIMM device of claim 1, wherein the SATA connector is arranged on a first side of the circuit board.

3. The SATA DIMM device of claim 1, wherein a first groove is defined in the first side of the circuit board and located under the SATA connector, and a second groove is defined in a second side of the circuit board opposite to the first side.

4. The SATA DIMM device of claim 1, wherein the bus pins transmit system management bus signals.

5. A motherboard for supporting a serial advanced technology attachment dual in-line memory module (SATA DIMM) device with a temperature sensor, the motherboard comprising:
a circuit board;
a SATA connector mounted on the circuit board;
a power connector mounted on the circuit board;
a switch mounted on the circuit board;
a fan mounted on the circuit board;
an integrated baseboard management controller (IBMC) mounted on the circuit board and connected to the switch and the fan;
a central processing unit (CPU) mounted on the circuit board; and
a memory slot mounted on the circuit board, and comprising a protrusion arranged in the memory slot, a plurality of power pins connected to the power connector, a plurality of ground pins, two bus pins connected to the switch, and a plurality of signal pins connected to the CPU;
wherein when the SATA DIMM device is connected to the memory slot and the switch is at a first state, the IBMC measures a temperature of the SATA DIMM device through the temperature sensor and the switch and controls a speed of the fan according to the measured temperature for dissipating heat from the SATA DIMM device; when a memory card is connected to the memory slot and the switch is at a second state, the CPU outputs a bus signal to the memory card through the switch for controlling the memory card to store data.

6. The motherboard of claim 5, wherein two fixing elements are respectively arranged on two ends of the memory slot.

7. The motherboard of claim 5, wherein the memory slot is a double data rate type three memory slot.

8. A motherboard assembly, comprising:
a motherboard comprising a first circuit board, a memory slot mounted on the first circuit board, a first serial advanced technology attachment (SATA) connector mounted on the first circuit board, a power connector mounted on the first circuit board, a switch mounted on the first circuit board, an integrated baseboard management controller (IBMC) mounted on the first circuit board, a fan mounted on the first circuit board, and a central processing unit (CPU) mounted on the first circuit board, the memory slot comprising a protrusion, a plurality of first power pins electrically connected to the power connector, a plurality of first ground pins, two first bus pins connected to the switch, and a plurality of signal pins connected to the CPU; and
a serial advanced technology attachment dual in-line memory module (SATA DIMM) device comprising a second circuit board, a second SATA connector arranged on the second circuit board, a power circuit arranged on the second circuit board, a plurality of storage chips arranged on the second circuit board and connected to the power circuit, a temperature sensor arranged on the second circuit board, a control chip arranged on the second circuit board and connected to the power circuit, the second SATA connector, and the storage chips, and an edge connector and a notch set on a bottom side of the second circuit board to be detachably engaged in the memory slot of the motherboard, the edge connector comprising a plurality of second power pins connected to the power circuit, a plurality of second ground pins, and two second bus pins connected to the temperature sensor;
wherein in response to the edge connector of the SATA DIMM device being engaged in the memory slot of the motherboard and the switch being at a first state, the protrusion is engaged in the notch, the second power pins of the SATA DIMM device are connected to the first power pins of the memory slot, the second ground pins of the SATA DIMM device are connected to the first ground pins of the memory slot, and the second bus pins of the SATA DIMM device are connected to the first bus pins of the memory slot, the power circuit receives a voltage from the power connector through the first and second power pins, the control chip receives a SATA signal from the motherboard through the first and second SATA connectors to control the storage chips to store data, the IBMC measures a temperature of the SATA DIMM device through the temperature sensor, the switch, and the first and second bus pins, and controls a speed of the fan; in response to a memory card being connected to the memory slot of the motherboard and the switch being at a second state, the CPU outputs a bus signal to the memory card through the switch and the first bus pins and also outputs a memory signal to the memory card through the signal pins of the memory slot.
